(19) United States
(12) Patent Application Publication
(10) Pub. No.: US 2025/0148412 A1
(43) Pub. Date: May 8, 2025

(54) TRAINED COMPUTER MODEL FOR IDENTIFICATION OF WRONG DELIVERY LOCATION FOR AN ORDER PLACED AT AN ONLINE SYSTEM

(71) Applicant: Maplebear Inc., San Francisco, CA (US)

(72) Inventors: Charles Wesley, San Diego, CA (US); Brent Scheibelhut, Toronto (CA); Hua Xiao, Toronto (CA)

(21) Appl. No.: 18/500,930

(22) Filed: Nov. 2, 2023

(51) Int. Cl. G06Q 10/083; G08B 21/18

(52) U.S. Cl. CPC G06Q 10/0838; G08B 21/182

(57) ABSTRACT

A trained computer model for automatic identification of a wrong delivery location for an order placed at an online system. The online system receives, via a user interface, a user input that includes a delivery location for the order. The online system compares the received delivery location with a stored delivery location for the user. Responsive to identifying that the received and stored delivery locations are different, the online system accesses and applies a computer model to predict, based on features of the order, a likelihood of the received delivery location being correct. The online system generates, based on the predicted likelihood, a confidence score of the received delivery location being correct. Responsive to the confidence score being below a threshold score, the online system causes a device of the user to display a user interface with a message prompting the user to verify accuracy of the received delivery location.

### BACKGROUND

Online systems, such as online concierge systems, enable users (i.e., customers) to order items (e.g., groceries) to different delivery locations. However, a user of an online concierge system may inadvertently select a wrong delivery location, especially if the user has recently changed the delivery location for a special occasion (e.g., vacation trip). Additionally, the user may have an incorrect delivery location stored at the online concierge system. This can happen when the user changes a delivery location for a short-term location (e.g., vacation address), and then subsequently places an order without updating the delivery location to their home address. Also, the user may have multiple home addresses stored at the online concierge system for delivery of ordered items. Hence, the user is currently forced to manually update the delivery location at the online concierge system every time the user changes his/her location.

Therefore, the current process for correcting the wrong delivery location is highly manual and thus not scalable. This leads to a technical problem of how to automatically identify a wrong delivery location for an order placed at the online concierge system at a large scale required by the online concierge system.

### SUMMARY

Embodiments of the present disclosure are directed to utilizing a trained computer model to automatically identify a wrong delivery location for an order placed at an online system (e.g., online concierge system).

In accordance with one or more aspects of the disclosure, the online system receives, via a user interface of the online system, an input from a user of the online system, the input including a delivery location for an order. The online system compares the received delivery location with a delivery location associated with the user stored in a database of the online system. Responsive to identifying that the received delivery location and the stored delivery location represent different delivery locations, the online system accesses a computer model of the online system trained to predict a likelihood of the received delivery location being correct. The online system applies the computer model to determine, based on one or more features of the order, the likelihood of the received delivery location being correct. The online system generates, based on the predicted likelihood, a confidence score of the received delivery location being correct. Responsive to the confidence score being below a threshold score, the online system causes a device of the user to display a user interface with a message prompting the user to verify accuracy of the received delivery location.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates an example user interface displayed at a user client device prompting a user of an online concierge system to verify accuracy of a delivery location for an order placed at the online concierge system, in accordance with one or more embodiments.

FIG. 4 is a flowchart for a method of using a computer model to predict a likelihood that a delivery location for an order placed at an online concierge system is accurate, in accordance with one or more embodiments.

### DETAILED DESCRIPTION

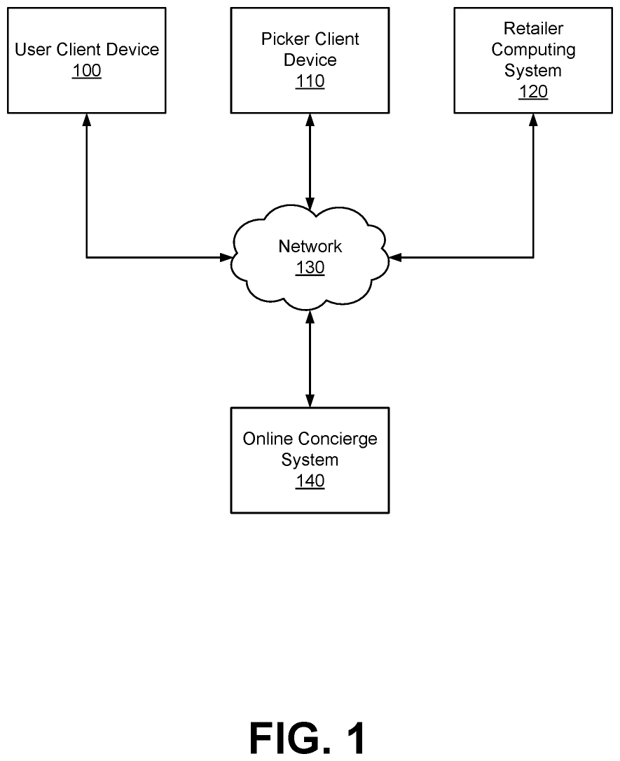

FIG. 1 illustrates an example system environment for an online concierge system 140, in accordance with one or more embodiments. The system environment illustrated in FIG. 1 includes a user client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item,” as used herein, means a good or product that can be provided to the user through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user, so that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from the user client device 100 through the network 130. The online concierge system 140 selects a picker to service the user's order and transmits the order to the picker client device 110 associated with the picker. The picker collects the ordered items from a retailer location and delivers the ordered items to the user. The online concierge system 140 may charge a user for the order and provide portions of the payment from the user to the picker and the retailer.

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140.

The online concierge system 140 receives orders from users of the online concierge system 140, and each order is associated with a delivery location of a corresponding user that placed that specific order. The users sometimes change their default delivery location for temporary locations, such as vacation homes, and then forget to change the delivery location back to their home address for a subsequent order, leading to delivery of the subsequent order at a wrong address. To avoid this, the online concierge system 140 applies a computer model (e.g., machine-learning model) trained to predict a likelihood of an order having an incorrect delivery location, which is especially critical to evaluate when the current delivery location is different than the user's current home address.

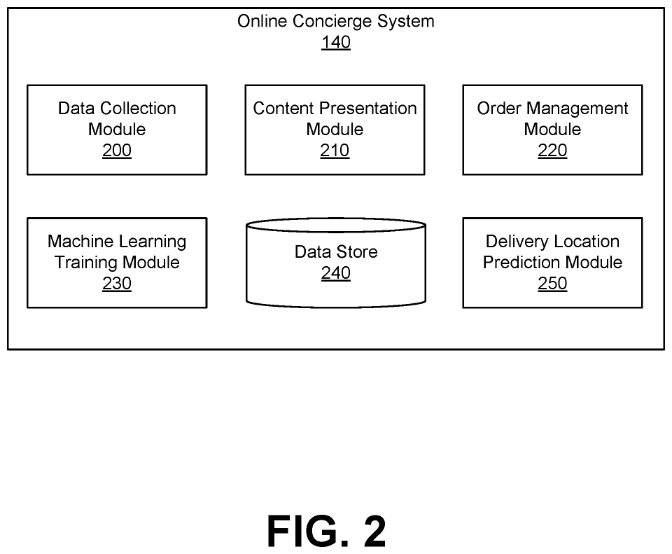

The computer model deployed by the online concierge system 140 may receive one or more input features that indicate whether contextual data about the order matches the current delivery location. The computer model may utilize features from past orders, including the usual delivery location for the past orders, the time of day and day of week for the past deliveries, and content of the past orders. For example, an order containing ready-to-eat items may be considered by the computer model as a sign that the order is associated with a short-term delivery location, whereas an order filled with staple ingredients is more likely to indicate a sustained residence. The computer model may specifically analyze catalog taxonomy information where indicative order content is used as an important factor in determining if the current delivery location is the regular delivery address of the user or just a temporary location. The computer model may further utilize information about global positioning system (GPS) location of the user (when available) to determine how probable it is that the current delivery location is different from the user's current ordering location. If the computer model predicts that the current delivery location is likely to be incorrect, the online concierge system 140 prompts the user to confirm the accuracy of the current delivery location for the order. Hence, the computer model is trained to detect, at a large scale, errors associated with users' delivery locations. The online concierge system 140 alerts users via the user client devices 100 about the detected errors or otherwise adds frictions to their user interfaces at the user client devices 100 to avoid these errors. The online concierge system 140 is described in further detail below with regards to FIG. 2.

FIG. 2 illustrates an example system architecture for the online concierge system 140, in accordance with some embodiments. The system architecture illustrated in FIG. 2 includes a data collection module 200, a content presentation module 210, an order management module 220, a machine-learning training module 230, a data store 240, and a delivery location prediction module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. For example, the data collection module 200 may collect the user data that include a user's name, address, shopping preferences, favorite items, or stored payment instruments. The data collection module 200 may collect the user data that also include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The data collection module 200 may collect the item data that include item identifiers for items that are available and may include quantities of items associated with each item identifier. Additionally, the data collection module 200 may collect the item data that also include attributes of items such as the size, color, weight, stock keeping unit (SKU), or serial number for the item. The data collection module 200 may collect the item data that further include purchasing rules associated with each item, if they exist. For example, age-restricted items such as alcohol and tobacco are flagged accordingly in the item data. The data collection module 200 may collect the item data that also include information that is useful for predicting the availability of items in retailer locations. For example, the data collection module 200 may collect the item data that include, for each item-retailer combination (a particular item at a particular warehouse), a time that the item was last found, a time that the item was last not found (a picker looked for the item but could not find it), the rate at which the item is found, or the popularity of the item. The data collection module 200 may collect the item data from the retailer computing system 120, the picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the data collection module 200 may collect the picker data for a picker that include the picker's name, the picker's location, how often the picker has serviced orders for the online concierge system 140, a user rating for the picker, which retailers the picker has collected items at, or the picker's previous shopping history. Additionally, the data collection module 200 may collect the picker data that include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects the picker data from sensors of the picker client device 110 or from the picker's interactions with the online concierge system 140.

Additionally, the data collection module 200 collects order data, which is information or data that describes characteristics of an order. For example, the data collection module 200 may collect the order data that include item data for items that are included in the order, a delivery location for the order, a user associated with the order, a retailer location from which the user wants the ordered items collected, or a timeframe within which the user wants the order delivered. Also, the data collection module 200 may collect the order data that further include information describing how the order was serviced, such as which picker serviced the order, when the order was delivered, or a rating that the user gave the delivery of the order. In some embodiments, the data collection module 200 collects the order data that include user data for users associated with the order, such as user data for a user who placed the order or picker data for a picker who serviced the order.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from the user client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use the user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online concierge system 140 has deployed the model to provide service to users. For example, if the machine-learning model is used to predict a likelihood of an outcome of an event, the online concierge system 140 may log the prediction and an observation of the actual outcome of the event. Alternatively, if the machine-learning model is used to classify an object, the online concierge system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online concierge system 140 as a whole in its performance of the tasks described herein.

The data store 240 stores data used by the online concierge system 140. For example, the data store 240 stores user data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The data store 240 may maintain (e.g., at a corresponding database) information about a delivery location (e.g., home address) for a user of the online concierge system 140. Furthermore, the data store 240 may store one or more additional delivery locations that the user enters via a user interface of the user client device 100, and each of the one or more additional delivery locations may be different than the home address. One of the delivery locations stored at the data store 240 may be labeled as an inferred (or default) delivery location for an order placed by the user. However, the inferred delivery location may not correspond to a current address of the user, which can lead to delivery of ordered items to a wrong delivery location. Also, the user may enter an incorrect delivery address that does not correspond to the current address of the user, leading to delivery to the incorrect delivery location.

The delivery location prediction module 250 may receive, via a user interface of the online concierge system 140 (e.g., from the user client device 100 via the network 130), an input from a user of the online concierge system 140, the input including a delivery location for an order. The delivery location prediction module 250 may receive from the user client device 100 the delivery location entered by the user via a user interface of the user client device 100, e.g., during a completion flow of the order. The delivery location prediction module 250 may compare the received delivery location with a delivery location associated with the user stored in a database of the online concierge system 140 (e.g., at the data store 240). Responsive to determining that the received delivery location and the stored delivery location represent different delivery locations, the delivery location prediction module 250 may access a computer model (e.g., machine-learning model) trained to predict a likelihood of the received delivery location being correct. Hence, the delivery location prediction module 250 may apply the trained computer model to predict a likelihood of a delivery location entered by the user matching an inferred address of the user, i.e., the likelihood of the delivery location entered by the user being correct.

The computer model deployed by the delivery location prediction module 250 may run a machine-learning algorithm to predict, based on one or more features of the order, the likelihood of the entered delivery location matching the inferred (i.e., stored) address of the user. Therefore, the computer model deployed by the delivery location prediction module 250 may be trained to operate as a probabilistic machine-learning computer model and can be referred to as a “probabilistic model”. A set of parameters for the computer model deployed by the delivery location prediction module 250 may be stored at one or more non-transitory computer-readable media of the delivery location prediction module 250. Alternatively, the set of parameters for the computer model deployed by the delivery location prediction module 250 may be stored at one or more non-transitory computer-readable media of the data store 240.

The delivery location prediction module 250 may prepare one or more inputs for input into the computer model. The one or more inputs to the computer model (e.g., as prepared by the delivery location prediction module 250) may include: information about content of the current order (e.g., “ready-to-eat” items suggesting a short-term location rather than staple ingredients that are likely to be intended for a long-term location), one or more features that characterize the order as being likely to be a short-term location order, one or more features that characterize the order as an outlier compared to orders that are typically delivered to the user's home address, day of week/time of user's past orders, day of week/time of the current order, etc. The one or more inputs to the computer model (e.g., as prepared by the delivery location prediction module 250) may further include: information about user's GPS locations at the time of previous orders, information about one or more user's GPS locations at the time of current order, cardinality of user's past ordering locations, preponderance of user's past ordering locations, information about user's past delivery locations (e.g., long-term location, short-term location), information about the current (default) delivery location, etc.

The one or more inputs to the computer model (e.g., as prepared by the delivery location prediction module 250) may further include information about catalog taxonomy makeup of the current order and of user's past orders. For example, a variety of taxonomy nodes underneath the “food” taxonomy node is more likely to be a “weekly shop” of groceries, and thus more likely to be intended for the user's long-term address. Items such as, produce, baking ingredients, eggs, milk, etc. are more likely to be intended for the user's long-term address. In contrast, “ready-to-eat” items, such as donuts, freezer meals, pint-size ice cream, bakery items, etc. are more compatible with a short-term delivery location. Smaller orders (i.e., orders with less taxonomy variety) are more compatible with a short-term delivery location. Also, “outlier orders” (i.e., orders where the taxonomic makeup does not match the user's past history) are more compatible with a short-term delivery location. Furthermore, the location and event driven makeup of an order, e.g., “tail gate,” “camping” or “picnic” is more compatible with a short-term delivery location.

The computer model deployed by the delivery location prediction module 250 may generate, as an output, information about a likelihood that the delivery location entered by the user is correct. The computer model may also generate, as part of the output, information about a delivery location (e.g., address) that is possible replacement for the current delivery location. If the computer model infers that the current delivery location is likely correct, no output may be generated by the computer model. The information about a likelihood that the entered delivery location for the order is correct may be generated by the computer model in the form of a confidence score of the entered delivery location. If the confidence score of the entered delivery location as determined by the computer model is equal to or below a threshold score (e.g., set by the delivery location prediction module 250), it is more likely that the entered delivery location is incorrect. In contrast, if the confidence score of the entered delivery location as determined by the computer model is above the threshold score, it is more likely that the entered delivery location is accurate.

Based on the output of the computer model (e.g., the confidence score being less than the threshold score), the content presentation module 210 may trigger an automatic action at a user interface of the user client device 100 of displaying (e.g., at checkout) a confirmation screen prompting the user to verify accuracy of the entered delivery location. Furthermore, the confirmation screen may include one or more alternative delivery locations that the user can select. If the user selects any of the suggested alternative delivery locations, the order management module 220 (or some other module of the online concierge system 140) may update the delivery location to correspond to the selected alternative delivery location. Additionally, the user's response to the confirmation screen displayed at the user interface of the user client device 100 may be recorded and provided to the machine-learning training module 230 for retraining (or, more generally, updating) the set of parameters of the computer model deployed by the delivery location prediction module 250.

In addition to predicting a likelihood that the entered delivery location is correct, the computer model may generate an output that triggers the content presentation module 210 to prompt the user at the user interface of the user client device 100 (or a picker at a user interface of the picker client device 110) after delivery to confirm a purpose of the order. For example, based on the event driven makeup of the order that includes terms such as “tail gate,” “camping,” and “picnic,” the content presentation module 210 may cause, based on the output of the computer model, the user client device 100 to display the user interface with a message “Was this order for a picnic?”. A user's response to this message may be recorded and provided to the machine-learning training module 230 for retraining the set of parameters of the computer model. Alternatively, instead of the computer model deployed by the delivery location prediction module 250, a language model (e.g., a large language model (LLM) that is not part of the online concierge system 140 or LLM that is integrated into the online concierge system 140) may be prompted to deduce what event the items in the order would typically be served at. For example, the prompt input to the language model can include an image of food items and a question, “What event might this collection of food items be for?” A response from the language model may be imported to the machine-learning training module 230 for updating the set of parameters of the computer model.

The machine-learning training module 230 may retrain (or, more generally, update) the computer model deployed by the delivery location prediction module 250 using information about the user's response to an alert displayed at the user interface of the user client device 100 about possible wrong delivery address. When the possibility of an erroneous delivery address is suggested to the user via the user client device 100, the user either indicates that the current delivery address is correct or accepts the change and fixes the error in relation to the delivery address. This represents ground truth labeled training data that is recorded (e.g., stored at the data store 240) and also provided to the machine-learning training module 230 for updating the set of parameters of the computer model. Anytime a delivery address confirmation screen is shown at the user interface of the user client device 100, the online concierge system 140 records information (e.g., at the data store 240) about whether the computer model was successful in predicting a high likelihood of the current delivery address being incorrect based on whether the user changes their delivery address. The recorded information is also passed to machine-learning training module 230 for updating the set of parameters of the computer model.

In one or more embodiments, when the delivery address confirmation screen is not shown at the user interface of the user client device 100 (e.g., due to a high likelihood of the current delivery address being correct, as predicted by the computer model), the machine-learning training module 230 may collect one or more comments from the user in relation to one or more past orders (e.g., as available at the data store 240). For example, the machine-learning training module 230 may collect a user's comment, such as “I accidentally got my groceries delivered to the wrong address”. The machine-learning training module 230 may use this information as ground truth labeled training data for training and retraining the computer model deployed by the delivery location prediction module 250. Thus, each time the address confirmation warning is responded to positively (e.g., “Yes, I'd like to move my delivery address”), or when an order issue arises because order items were delivered to an unanticipated address, these instances are recorded and employed by the machine-learning training module 230 to train and retrain the computer model.

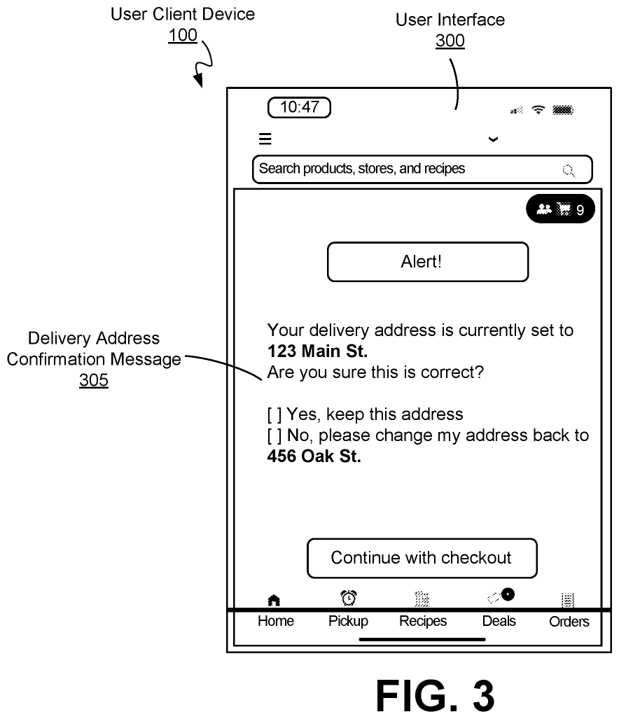

FIG. 3 illustrates an example user interface 300 displayed at the user client device 100 prompting a user of the online concierge system 140 to verify accuracy of a delivery location for an order placed at the online concierge system 140, in accordance with one or more embodiments. The user interface 300 may be displayed, e.g., at the order's checkout. Based on a confidence score of a delivery location entered by the user (e.g., as determined by the computer module deployed by the delivery location prediction module 250), the content presentation module 210 may cause the user client device 100 to display the user interface 300 with a delivery address confirmation message 305 that prompts the user to verify accuracy of the delivery location, as well as to select an alternative delivery location if the current delivery location is incorrect. Upon verifying accuracy of the delivery location for the order, the user can proceed with the checkout. Note that the user may opt to ignore the delivery address confirmation message 305 and immediately proceed with the checkout without verifying accuracy of the delivery location.

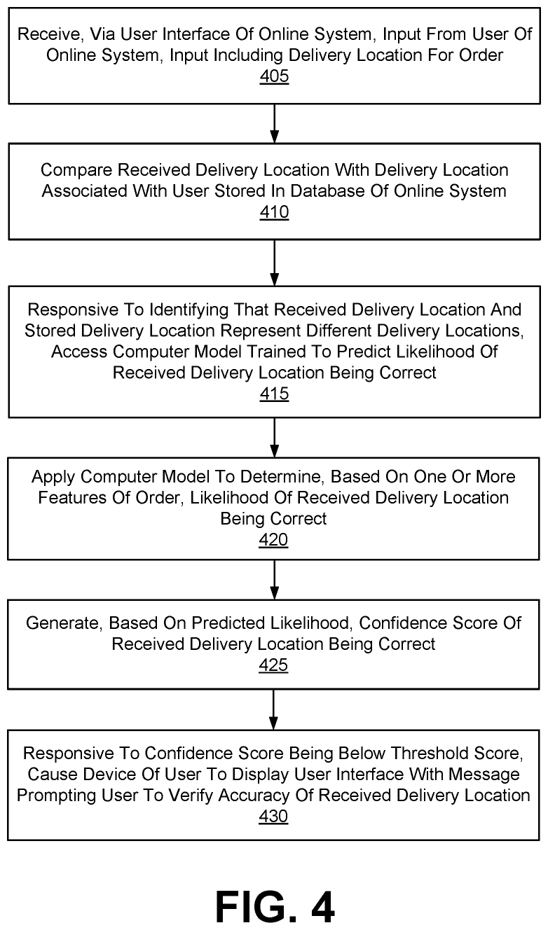

FIG. 4 is a flowchart for a method of using a computer model to predict a likelihood that a delivery location for an order placed at an online concierge system is accurate, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

The online concierge system 140 receives 405, via a user interface of the online concierge system 140 (e.g., from the user client device 100 via the network 130), an input from a user of the online concierge system 140, the input including a delivery location for an order. The online concierge system 140 may receive, from a device of the user (e.g., the user client device 100), the delivery location entered by the user via a user interface of the device of the user during a completion flow of the order.

The online concierge system 140 compares 410 (e.g., via the delivery location prediction module 250) the received delivery location with a delivery location associated with the user stored in a database of the online concierge system 140 (e.g., at the data store 240). Responsive to identifying that the received delivery location and the stored delivery location represent different delivery locations, the online concierge system 140 accesses 415 a computer model (e.g., via the delivery location prediction module 250) trained to predict a likelihood of the received delivery location being correct.

The online concierge system 140 applies 420 the computer model (e.g., via the delivery location prediction module 250) to predict, based on one or more features of the order, the likelihood of the received delivery location being correct. The online concierge system 140 generates 425 (e.g., via the computer model), based on the predicted likelihood, a confidence score of the received delivery location being correct. The online concierge system 140 may compare (e.g., via the delivery location prediction module 250) the confidence score with a defined threshold score. Responsive to the confidence score being below the threshold score, the online concierge system 140 causes 430 (e.g., via the content presentation module 210) a device of the user (e.g., the user client device 100) to display a user interface with a message prompting the user to verify accuracy of the received delivery location.

The online concierge system 140 may generate (e.g., via the delivery location prediction module 250) the one or more features of the order for inputting into the computer model so that the one or more features indicate whether contextual data associated with the order matches the stored delivery location. The online concierge system 140 may generate (e.g., via the delivery location prediction module 250) the one or more features of the order for inputting into the computer model so that the one or more features include at least one of: content of the order, content of one or more previous orders placed by the user, one or more GPS locations associated with the user when placing the order, one or more past delivery locations of the user, a level of taxonomic variety associated with the order, a timestamp of the order, or one or more timestamps of the one or more previous orders.

The online concierge system 140 may apply the computer model (e.g., via the delivery location prediction module 250) to identify, based at least in part on the predicted likelihood and the one or more features of the order, an alternative delivery location for the order. The online concierge system 140 may cause (e.g., via the content presentation module 210) the device of the user to display the user interface further with the stored delivery location and the alternative delivery location prompting the user to select the stored delivery location or the alternative delivery location for the order. The online concierge system 140 may update (e.g., via the machine-learning training module 230) the set of parameters of the computer model using information that the user selected the stored delivery location. The online concierge system 140 may label (e.g., via the order management module 220 or the delivery location prediction module 250), based on a response by the user to the communication message in relation to the accuracy of the received delivery address, the received delivery location as an inferred delivery location associated with the user.

The online concierge system 140 may generate (e.g., via the machine-learning training module 230), based on a response by the user to the displayed message, feedback data comprising information about the accuracy of the received delivery location. The online concierge system 140 may update (e.g., via the machine-learning training module 230) the set of parameters of the computer model using the generated feedback data. The online concierge system 140 may obtain (e.g., from the data store 240 via the machine-learning training module 230) ground truth labeled training data with information about accuracies of a set of delivery locations of one or more orders, wherein the information is obtained based on a set of responses by one or more users of the online concierge system 140. The online concierge system 140 may train the computer model (e.g., via the machine-learning training module 230) using the ground truth labeled training data. The online concierge system 140 may obtain (e.g., via the network 130) and maintain (e.g., at the data store 240) one or more feedback messages from one or more users of the online concierge system 140, each of the one or more feedback messages associated with an accuracy of a delivery address for a corresponding order placed at the online concierge system 140. The online concierge system 140 may update (e.g., via the machine-learning training module 230) the set of parameters of the computer model using the one or more feedback messages.

Embodiments of the present disclosure are directed to the online concierge system 140 that employs a computer model trained to predict whether a delivery location (e.g., delivery address) associated with a current order is incorrect based on the profile of items in the current order and various other contextual information of the current order compared to previous orders of the same user and one or more delivery addresses used in the previous orders. The trained computer model operates as a contextual profile analyzer associated with one or more addresses in connection with a user's account at the online concierge system 140. The trained computer model presented herein helps prevent users from unintentionally ordering items to the wrong address through the use of historical order data and taxonomy information. At the time of ordering, the predictive algorithm presented herein determines whether to show a warning to the user in case of possible incorrect delivery, greatly reducing the possibility of error and increasing the overall user experience.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method, performed at a computer system comprising a processor and a computer-readable medium, comprising:
receiving, via a user interface of an online system, an input from a user of the online system, the input including a delivery location for an order;
comparing the received delivery location with a delivery location associated with the user stored in a database of the online system;
responsive to identifying that the received delivery location and the stored delivery location represent different delivery locations, accessing a machine-learning model of the online system, wherein the machine-learning model is trained to predict a likelihood of the received delivery location being correct, the machine-learning model trained by:
generating training data that include labels about whether delivery locations for orders placed at the online system by users of the online system were accurate, the labels generated based on responses by the users about accuracies of the delivery locations, and
generating, using the training data, a set of initial values for a set of parameters of the machine-learning model;
receiving, via a network from a device associated with the user, user data collected by sensors on the device, the user data including information about a location of the device when the user placed the order;
applying the machine-learning model to one or more features of the order and the information about the location of the device to predict the likelihood of the received delivery location being correct;
generating, based on the predicted likelihood, a confidence score of the received delivery location being correct;
responsive to the confidence score being below a threshold score, generating a user interface of the device displaying a confirmation screen with one or more alternative delivery locations prompting the user to verify accuracy of the received delivery location;
receiving, from the device and via the network, a response by the user to the confirmation screen that corrects an error in relation to the delivery location and was recorded at the device;
replacing, based on the response by the user, the delivery location in the database with an updated delivery location of the one or more alternative delivery locations; and
re-training the machine-learning model by updating, using the received response, the set of parameters of the machine-learning model.

2. The method of claim 1, wherein receiving the input from the user comprises:
receiving, from the device of the user, the delivery location entered by the user via the user interface of the device of the user during a completion flow of the order.

3. The method of claim 1, further comprising:
generating the one or more features of the order for inputting into the machine-learning model so that the one or more features indicate whether contextual data associated with the order matches the stored delivery location; and
comparing the generated confidence score with the threshold score.

4. The method of claim 1, further comprising:
generating the one or more features of the order for inputting into the machine-learning model so that the one or more features include at least one of: content of the order, content of one or more previous orders placed by the user, one or more global positioning system (GPS) locations associated with the user when placing the order, one or more past delivery locations of the user, a level of taxonomic variety associated with the order, a timestamp of the order, or one or more timestamps of the one or more previous orders.

5. The method of claim 1, further comprising:
generating, based on the response by the user, feedback data comprising information about the accuracy of the received delivery location; and
updating the set of parameters of the machine-learning model using the generated feedback data.

6. The method of claim 1, further comprising:
obtaining ground truth labeled training data with information about accuracies of a set of delivery locations of one or more orders, the information obtained based on a set of responses by one or more users of the online system; and
training the machine-learning model using the ground truth labeled training data.

7. The method of claim 1, wherein applying the machine-learning model further comprises:
applying the machine-learning model to identify, based at least in part on the predicted likelihood and the one or more features of the order, an alternative delivery location for the order.

8. The method of claim 7, further comprising:
causing the device of the user to display the user interface further with the stored delivery location and the alternative delivery location prompting the user to select the stored delivery location or the alternative delivery location for the order.

9. The method of claim 8, further comprising:
updating the set of parameters of the machine-learning model using information that the user selected the stored delivery location.

10. The method of claim 1, further comprising:
obtaining one or more feedback messages from one or more users of the online system, each of the one or more feedback messages associated with an accuracy of a delivery address for a corresponding order placed at the online system; and
updating the set of parameters of the machine-learning model using the one or more feedback messages.

11. The method of claim 1, further comprising:
labeling, based on the response by the user, the received delivery location as an inferred delivery location associated with the user.

12. A computer program product comprising a non-transitory computer readable storage medium having instructions encoded thereon that, when executed by a processor, cause the processor to perform steps comprising:
receiving, via a user interface of an online system, an input from a user of the online system, the input including a delivery location for an order;
comparing the received delivery location with a delivery location associated with the user stored in a database of the online system;
responsive to identifying that the received delivery location and the stored delivery location represent different delivery locations, accessing a machine-learning model of the online system, wherein the machine-learning model is trained to predict a likelihood of the received delivery location being correct, the machine-learning model trained by:
generating training data that include labels about whether delivery locations for orders placed at the online system by users of the online system were accurate, the labels generated based on responses by the users about accuracies of the delivery locations, and
generating, using the training data, a set of initial values for a set of parameters of the machine-learning model;
receiving, via a network from a device associated with the user, user data collected by sensors on the device, the user data including information about a location of the device when the user placed the order;
applying the machine-learning model to one or more features of the order and the information about the location of the device to predict the likelihood of the received delivery location being correct;
generating, based on the predicted likelihood, a confidence score of the received delivery location being correct;
responsive to the confidence score being below a threshold score, generating a user interface of the device displaying a confirmation screen with one or more alternative delivery locations prompting the user to verify accuracy of the received delivery location;
receiving, from the device and via the network, a response by the user to the confirmation screen that corrects an error in relation to the delivery location and was recorded at the device;
replacing, based on the response by the user, the delivery location in the database with an updated delivery location of the one or more alternative delivery locations; and
re-training the machine-learning model by updating, using the received response, the set of parameters of the machine-learning model.

13. The computer program product of claim 12, wherein the instructions further cause the processor to perform steps comprising:
generating the one or more features of the order for inputting into the machine-learning model so that the one or more features indicate whether contextual data associated with the order matches the stored delivery location.

14. The computer program product of claim 12, wherein the instructions further cause the processor to perform steps comprising:
generating the one or more features of the order for inputting into the machine-learning model so that the one or more features include at least one of: content of the order, content of one or more previous orders placed by the user, one or more global positioning system (GPS) locations associated with the user when placing the order, one or more past delivery locations of the user, a level of taxonomic variety associated with the order, a timestamp of the order, or one or more timestamps of the one or more previous orders.

15. The computer program product of claim 12, wherein the instructions further cause the processor to perform steps comprising:
generating, based on the response by the user, feedback data comprising information about the accuracy of the received delivery location; and
updating the set of parameters of the machine-learning model using the generated feedback data.

16. The computer program product of claim 12, wherein the instructions further cause the processor to perform steps comprising:
obtaining ground truth labeled training data with information about accuracies of a set of delivery locations of one or more orders, the information obtained based on a set of responses by one or more users of the online system; and
training the machine-learning model using the ground truth labeled training data.

17. The computer program product of claim 12, wherein the instructions further cause the processor to perform steps comprising:
applying the machine-learning model to identify, based at least in part on the predicted likelihood and the one or more features of the order, an alternative delivery location for the order;
causing the device of the user to display the user interface further with the stored delivery location and the alternative delivery location prompting the user to select the stored delivery location or the alternative delivery location for the order; and
updating the set of parameters of the machine-learning model using information that the user selected the stored delivery location.

18. The computer program product of claim 12, wherein the instructions further cause the processor to perform steps comprising:
obtaining one or more feedback messages from one or more users of the online system, each of the one or more feedback messages associated with an accuracy of a delivery address for a corresponding order placed at the online system; and
updating the set of parameters of the machine-learning using the one or more feedback messages.

19. The computer program product of claim 12, wherein the instructions further cause the processor to perform steps comprising:
labeling, based on the response by the user, the received delivery location as an inferred delivery location associated with the user.

20. A computer system comprising:
a processor; and
a non-transitory computer-readable storage medium having instructions that, when executed by the processor, cause the computer system to perform steps comprising:
receiving, via a user interface of an online system, an input from a user of the online system, the input including a delivery location for an order;
comparing the received delivery location with a delivery location associated with the user stored in a database of the online system;
responsive to identifying that the received delivery location and the stored delivery location represent different delivery locations, accessing a machine-learning model of the online system, wherein the machine-learning model is trained to predict a likelihood of the received delivery location being correct, the machine-learning model trained by:
generating training data that include labels about whether delivery locations for orders placed at the online system by users of the online system were accurate, the labels generated based on responses by the users about accuracies of the delivery locations, and
generating, using the training data, a set of initial values for a set of parameters of the machine-learning model;
receiving, via a network from a device associated with the user, user data collected by sensors on the device, the user data including information about a location of the device when the user placed the order;
applying the machine-learning model to one or more features of the order and the information about the location of the device to predict the likelihood of the received delivery location being correct;
generating, based on the predicted likelihood, a confidence score of the received delivery location being correct;
responsive to the confidence score being below a threshold score, generating a user interface of the device displaying a confirmation screen with one or more alternative delivery locations prompting the user to verify accuracy of the received delivery location;
receiving, from the device and via the network, a response by the user to the confirmation screen that corrects an error in relation to the delivery location and was recorded at the device;
replacing, based on the response by the user, the delivery location in the database with an updated delivery location of the one or more alternative delivery locations; and
re-training the machine-learning model by updating, using the received response, the set of parameters of the machine-learning model.
